(19) United States
(12) Patent Application Publication
(10) Pub. No.: US 2018/0331701 A1
(43) Pub. Date: Nov. 15, 2018

(54) WEARABLE DEVICE USING MULTI-WIRE TRANSMISSION

(71) Applicants: SHU-LING CHEN, TAIPEI CITY (TW); CHIH-TE CHANG, TAIPEI CITY (TW)

(72) Inventor: PAO-CHIN CHANG, TAIPEI CITY (TW)

(21) Appl. No.: 15/975,870

(22) Filed: May 10, 2018

(30) Foreign Application Priority Data
May 10, 2017 (TW) 106115458

(51) Int. Cl. H04B 1/034; H04B 1/08; H04B 1/16; H04B 1/04; H04B 3/06

(52) U.S. Cl. CPC H04B 1/0343; H04B 1/088; H04B 3/06; H04B 1/0483; H04B 1/1607

(57) ABSTRACT

A wearable device using multi-wire transmission is described. The wearable device using multi-wire transmission has a first fastener and a plurality of detachable second fasteners. Further, the first fastener is communicated with the second fasteners to transmit different pulse wave signals or different digital signals via multi-wire transmission when the first fastener is bonded to the second fasteners, such that all of the functional elements of the second fasteners such as a touchpad, a screen, a heating film, etc. combined with the first fastener are integrated.

### BACKGROUND

### 1. Technical Field

The present disclosure involves to a wearable device using multi-wire transmission, and more particularly to a wearable device using multi-wire where the electronic modules distributed across the wearable device are integrated by using a three-wire, four-wire, or five-wire transmission.

### 2. Description of Related Art

Clothing and accessories such as clothes, coats, apparels, pants, footwear, gloves, hats, hair clips, brooches, scarves, raincoats, rain gears, backpacks, handbags, bags, suitcases, etc., are closely related to our everyday life. For example, all people need to wear clothes. People may wear cooler clothes under hot weather, or warmer jackets under cold weather. Raincoats or rain gears may be used when it is raining, and handbags may be used when shopping. In other words, clothing and accessories are inseparable from our daily lives.

With the advancement of technology, the existing industry has developed various smart wearable devices. For example, smart watches, smart wristbands, smart headphones or other wearable devices. However, these wearable devices often have only preset functions and cannot be expanded with other functions, or even if they can, the functions cannot be integrated effectively, resulting in inconvenience for the user of a smart wearable device.

### SUMMARY

In view of the above, the present disclosure provides a wearable device using multi-wire transmission, including: a first fastener having a first contact point, a second contact point, a third contact point and a fourth contact point, and a plurality of second fasteners each having a sixth contact point, a seventh contact point, an eighth contact point and a ninth contact point, and each being detachably bonded to the first fastener. The first fastener includes a first processor configured to store a plurality of command signals and a plurality of communication protocols. The first fastener selects one of the plurality of command signals and generates a pulse width signal to be transmitted to the first contact point according to the selected command signal, wherein the pulse width signal represents the selected command signal. The first contact point, the second contact point, the third contact point and the fourth contact point are electrically connected to the sixth contact point, the seventh contact point, the eighth contact point and the ninth contact point of each of the plurality of second fasteners, respectively, when the first fastener is bonded to the plurality of second fasteners, and the sixth contact point of each of the plurality of second fasteners receives the pulse width signal from the first contact point and generates at least one response signal to be transmitted through both or one of the eighth contact point and the ninth contact point to the first fastener according to the pulse width signal. The third contact point and the fourth contact point of the first fastener receive each of the corresponding response signals to obtain a related message of each of the plurality of second fasteners when the first fastener is bonded to the plurality of second fasteners, wherein one of the plurality of second fasteners performs signal transmission with the first fastener according to any one of the plurality of communication protocols.

To make the above features and advantages of the present disclosure can be more clearly and easily understood, the following preferred embodiments will be described in detail with reference to the accompanying drawings.

### BRIEF DESCRIPTION OF THE DRAWINGS

FIG. 1A is a schematic diagram of a wearable device using multi-wire transmission according to an embodiment of the present disclosure.

FIG. 1B is a schematic diagram of a wearable device using multi-wire transmission according to an embodiment of the present disclosure.

FIG. 2 is a schematic diagram of a first fastener according to an embodiment of the present disclosure.

FIG. 3A is a schematic diagram of a pulse width signal according to an embodiment of the present disclosure.

FIG. 3B is a schematic diagram of a pulse width signal according to another embodiment of the present disclosure.

FIG. 4A is a circuit diagram of a pulse width generator according to an embodiment of the present disclosure.

FIG. 4B is a circuit diagram of a first current protector according to an embodiment of the present disclosure.

FIG. 5 is a schematic diagram of a second fastener according to an embodiment of the present disclosure.

FIG. 6A is a circuit diagram of a signal detector according to an embodiment of the present disclosure.

FIG. 6B is a circuit diagram of a signal detector according to another embodiment of the present disclosure.

FIG. 6C is a circuit diagram of a signal detector according to another embodiment of the present disclosure.

FIG. 6D is a circuit diagram of a signal detector according to another embodiment of the present disclosure.

FIG. 7 is a schematic diagram of a second fastener according to another embodiment of the present disclosure.

FIG. 8A and FIG. 8B are schematic diagrams of a first fastener and second fasteners operating cooperatively according to an embodiment of the present disclosure.

FIG. 9A to FIG. 9C are configuration diagrams of the first contact point, the second contact point, the third contact point, the fourth contact point and the fifth contact point according to an embodiment of the present disclosure.

FIG. 10 is a schematic diagram of a belt as a wearable device using multi-wire transmission according to an embodiment of the present disclosure.

FIG. 11 is a schematic diagram of a piece of clothing and pants as wearable devices using multi-wire transmission according to an embodiment of the present disclosure.

FIG. 12 is a schematic diagram of a wearable device using multi-wire transmission according to another embodiment of the present invention.

### DESCRIPTION OF THE EXEMPLARY EMBODIMENTS

The exemplary embodiments will be described below in more detail with reference to the accompanying drawings. The inventive concepts may be embodied in many different forms and should not be construed as being limited to the exemplary embodiments set forth herein. Rather, these embodiments are provided so that this disclosure will be thorough and complete, and will fully convey the scope of the inventive concept to those skilled in the art. In the drawings, the sizes and relative sizes of layers and regions may be exaggerated for clarity. Like reference numbers refer to like elements throughout.

It will be understood that, although the terms “first”, “second”, “third”, and the like may be used herein to describe various elements, these elements should not be limited by these terms. These terms are only used to distinguish one element from another element. Therefore, the first element discussed below may he referred to as a second element without departing from the teachings of the inventive concept. As used herein, the term “and/or comprises any one of and one or more combinations of the associated listed items.

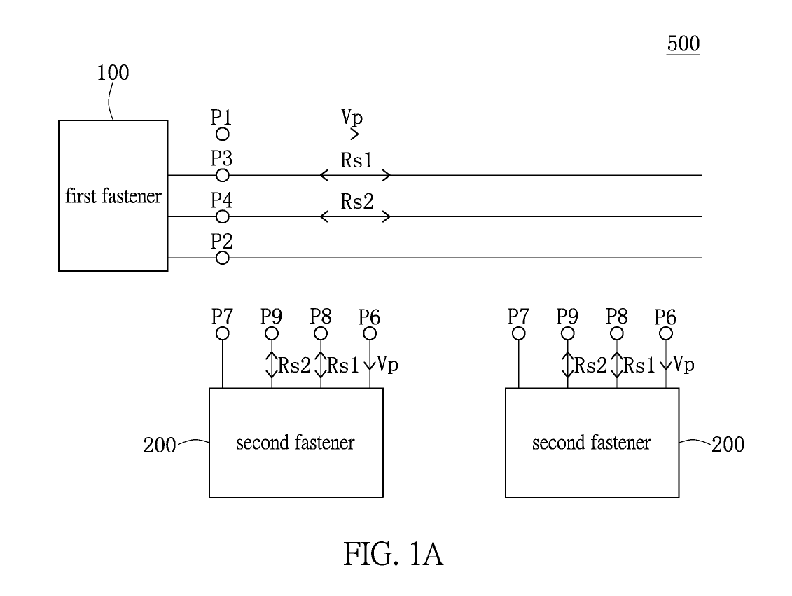

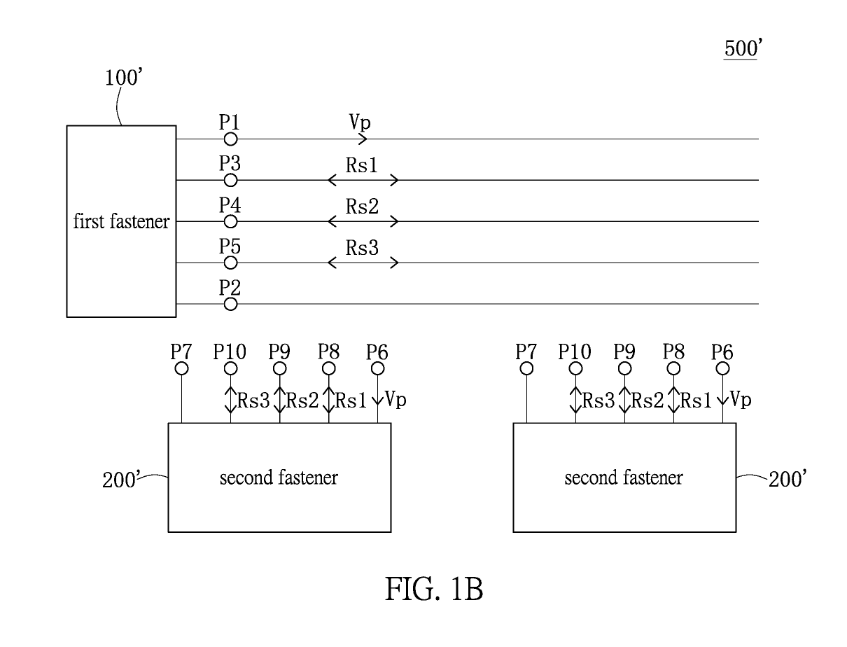

Reference is first made to FIGS. 1A and 1B, schematic diagrams of four-wire and five-wire wearable devices using multi-wire transmission according to an embodiment of the present disclosure respectively are shown. As shown in FIG. 1A, the wearable device 500 using four-wire transmission includes a first fastener 100 and a plurality of second fasteners 200. The first fastener 100 is integrated with the functional elements of each of the plurality of second fasteners 200 such as touchpads, screens, heating films, etc., such that the first fastener 100 may control or perform data transmission with each of the plurality of second fasteners 200 when the first fastener 100 is combined with the plurality of second fasteners 200. In the present disclosure, the first fastener 100 and the plurality of second fasteners 200 are detachably disposed on the wearable device 500, and the configuration manner thereof can be adjusted according to actual requirements, the present disclosure is not limited thereto.

The first fastener 100 has a first contact point P1, a second contact point P2 as a grounding point, a third contact point P3 and a fourth contact point P4. The third contact point P3 and the fourth contact point P4 are unidirectional or bidirectional data transmission points. The first fastener 100 stores a plurality of command signals and a plurality of communication protocols. The first fastener 100 may be placed on a mezzanine, an inner layer, an under layer or a pocket of clothes, pants and the like, or may take the form of decorations, accessories and trademarks, etc., but the present disclosure is not limited thereto.

The wearable device 500′ using five-wire transmission as shown in FIG. 1B has a structure similar to that of the wearable device 500 using four-wire transmission. However, the difference is that the first fastener 100′ of the wearable device 500′ using five-wire transmission has a first contact point P1, a second contact point P2 as a grounding point, a third contact point P3, a fourth contact point P4 and a fifth contact point P5. The third contact point P3, the fourth contact point P4 and the fifth contact point P5 are unidirectional or bidirectional data transmission points, signifying that the structural difference between the wearable device 500′ using five-wire transmission and the wearable device 500 using four-wire transmission is mainly that they have different numbers of transmission contact points and amount of data transmitted. Furthermore, the four-wire wearable device 500 and the five-wire wearable device 500′ are applicable or compatible with different common, unusual or customized transmission protocols, respectively.

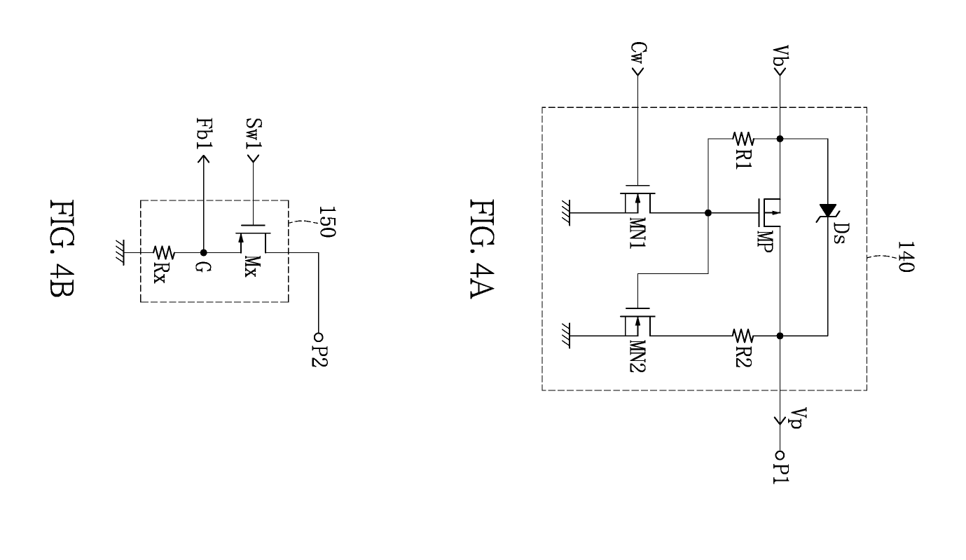

The first contact point P1 not only supplies a DC power of 3 VDC to 24 VDC (depending on particular implementation), but also sends a command signal to the pulse width generator 140 by the first processor 110 such that the pulse width generator 140 generates a pulse width waveform Vp having a small amplitude at the first contact point P1 based on the command signal. For example, a voltage difference of 0.7V (for example, Ds in FIG. 4A represents a general diode) or 0.3V (for example, Ds in FIG. 4A represents a Schottky diode) is generated at the first contact point P1, such that the waveform change of 5V to 4.3V or 4.7V is generated at the first contact point P1, and thus forms different command signals having various pulse width waveforms Vp. For example, the command signal represents calling to all of the second fasteners 200 combined with the first fastener 100. For another example, the command signal represents searching for the second fasteners 200 having specific functions such as a sensor function. More importantly, the command signal of the first fastener 100 may be issued to the plurality of second fasteners 200 having the same or different communication protocols such as a communication protocol 1 and a communication protocol 2, at different times in the same system. When the first fastener 100 issues a command for using the communication protocol 1 at a time t1, the plurality of second fasteners 200 using the communication protocol 1 and the first fasteners 100, 100′ start to transmit data to each other via a first response signal Rs1, a second response signal Rs2 or a third response signal Rs3, and other second fasteners 200 using the communication protocol 2 and the first fastener 100 do not transmit data temporarily to each other. When the first fastener 100 issues a. command for instructing to use the communication protocol 2 at a time t2, the plurality of second fasteners 200 using the communication protocol 2 and the first fasteners 100, 100′ start to transmit data with each other via the first response signal Rs1, the second response signal Rs2 (four-wire transmission) or via the first response signal Rs1, the second response signal Rs2 and the third response signal Rs3 (five-wire transmission), and other second fasteners 200 using the communication protocol 1 and the first fastener 100 temporarily do not transmit data to each other.

The advantage of the method described above is that the plurality of second fasteners 200 or 200′ that have originally different communication protocols can exist in the same system simultaneously. The first fasteners 100, 100′ issue different command signals at different times, such as a time t3, through the first contact point P1 to instruct that only the plurality of second fasteners 200, 200′ using an instructed communication protocol such as a communication protocol 3 can perform data transmission with the first fasteners 100, 100′ at an instructed time via the response signal Rs. In this way, the second fasteners 200, 200′ having different communication protocols that are originally incompatible with each other can co-exist in the same system. More importantly, since the common 1-Wire communication protocol modules or devices can be easily modified into the second fasteners 200, 200′, it is also more convenient for system engineers or partnered manufacturers to develop the second fasteners 200, 200′ having familiar communication protocols, or a third party can develop second fasteners 200, 200′ having its own unique communication protocol to distinguished themselves from other commercially available products. The present disclosure is not limited to the command signals and the communication protocols disclosed herein. In this embodiment, the second fasteners 200, 200′ stores at least one of the plurality of communication protocols that are stored in the first fasteners 100, 100′. That is, any communication protocol that may be used and recognized by the second fastener 200, 200′ is available in the first fastener 100, 100′. In other words, the plurality of second fasteners 200, 200′ may have the same or different communication protocols, which are also may be used, recognized and parsed by the first fasteners 100, 100′. On the other hand, when the first fasteners 100, 100′ intend to select one or more of the second fasteners 200, 200′having a first communication protocol, that is, when the first processor 110 issues command signals to the pulse width generators 140 such that the pulse width generators 140 generate pulse width signals Vp to be transmitted to the plurality of second fasteners 200, 200′, only the second fasteners 200, 200′ that are capable of recognizing and parsing the first communication protocol can generate the corresponding data according to the different signal contents of the pulse width signals Vp, and then returns data to or reciprocates data with the first fasteners 100, 100′ via the response signals Rs.

The pulse width signal Vp represents the selected command signal. The relationship between the first fasteners 100, 100′, the pulse width signals Vp (command signals) and the second fasteners 200, 200° will be described in the following embodiment, and will not be redescribed herein.

In this embodiment, the first fastener 100 and the second fasteners 200, 200′ may use the communication protocol such as Microchip 1-Wire, TI 1-Wire, Maxim 1-Wire, DALLAS 1-Wire, Single-Wire Protocol, Lin. Bus, CAN Bus, self-developed, or custom-made new 1-Wire communication protocols. In addition, the communication protocols also includes the common I2C, I3C, I2S, SPI, USI, SSP, SIM, UART (including: RS232, RS449, RS423, RS422, RS485, etc.), Mini USB, Micro USB, IPMI, MIPI, SMBus_System Management Bus, GPIO, or others communication protocols that may be used for communication between the first fastener 100 and the second fastener 200. The present disclosure is not limited thereto.

As shown in FIGS. 1A and 1B, each of the plurality of second fasteners 200 or 200′ has a sixth contact point P6 and a seventh contact point P7.

The sixth contact points P6 of the second fastener 200 and the second fastener 200′ are electrically connected to the first contact points P1 of the first fastener 100 and the first fastener 100′ in a detachable manner, respectively. The seventh contact points P7 of the second fastener 200 and the second fastener 200′ are electrically connected to the second contact points P2 of the first fastener 100 and the first fastener 100′ in a detachable manner, respectively.

As shown FIG. 1A, the second fastener 200 using the four-wire transmission not only has the sixth contact point P6 for transmitting and receiving the pulse width signal and the seventh contact P7 as the grounding point, but also has two signal transmission contact points, which are an eighth contact point P8 and a night contact point P9 respectively. The eighth contact point P8 and the night contact point P9 are used for transmitting a first response signal Rs1 and a second response signal Rs2 respectively.

As shown FIG. 1B, the second fastener 200′ using the five-wire transmission not only has the sixth contact point P6 for transmitting and receiving the pulse width signal and the seventh contact P7 as the grounding point, but also has three transmission contact points, which are an eighth contact point P8, a ninth contact point P9 and a tenth contact point P10 respectively. The eighth contact point P8, the ninth contact point P9 and the tenth contact point P10 are used for transmitting a first response signal Rs1, a second response signal Rs2 and a third response signal Rs3, respectively.

The second fasteners 200, 200′ are detachably combined with the first fasteners 100, 100′. Therefore, when the first fasteners 100, 100′ are not combined with the second fasteners 200, 200′, they will not be integrated with the application function of the second fasteners 200, 200′. In contrast, the first contact points P1, the second contact points P2 are electrically connected to the sixth contact points P6 and the seventh contact points P7 of the second fasteners 200, 200′ when the first fasteners 100, 100′ are combined with the plurality of second fasteners 200, 200′. At this time, the first fasteners 100, 100′ are connected in parallel or in series with the plurality of second fasteners 200, 200′, the contact points P2 and the seventh contact points P7 are the grounding points.

The second fasteners 200, 200′ can not only be placed in a mezzanine, an inner layer, an under layer and a pocket of clothes, pants and the like in the form of fasteners, but can also take the form of accessories, jewelry, armbands, badges, badges, trademarks, buckles, straps and the like of clothes, pants, hats, socks, shoes, scarves or backpacks, etc., but the present disclosure is not limited thereto.

Different second fasteners 200, 200′ have different equipment numbers or device numbers serving as identifiers, and a communication protocol. Any newly added second fasteners 200, 200′ returns its device numbers to be identified by the first fasteners 100, 100′ in real time when the first fasteners 100, 100′ issue the command signals for inquiring whether or not there are any newly added devices. When the first fasteners 100, 100′ require use of specific devices among the plurality of second fasteners 200, 200′ having different communication protocols specified at different time points, the second fasteners 200 having the device numbers of the specific devices (among the second fasteners 200 using the instructed communication protocols) transmit data with the first fasteners 100, 100′ via the first response signal Rs1 and the second response signal Rs2 (four-wire transmission), or via the first response signal Rs1, the second response signal Rs2 and the third response signal Rs3 (five-wire transmission). In other words, the first fasteners 100, 100′ may specify one of the plurality of second fasteners 200, for example, the first fasteners 100, 100′ require the second fasteners 200, 200′ having the heartbeat measurement function to return heartbeat data, or the first fasteners 100, 100′ may transmit the data to the second fasteners 200, 200′ having a liquid crystal displaying (LCD) function or having an organic light emitting diode displaying (OLED) function via the communication protocol.

For another example, the first fasteners 100, 100′ may, at the same time, inquire whether all of the plurality of second fasteners 200, 200′ having the different communication protocols need interrupt service. For example, those inquired second fasteners may be touch buttons, voice input devices, or sensing devices that require immediate processing, such as a fire alarm, an anti-theft sensor, an earthquake sensor, an anti-collision sensor for cars, locomotives and bicycles, a toxic gas sensor, and an emergency pager for women or the elderly, etc.

In this embodiment, when the third contact points P3, the fourth contact points P4 or the fifth contact points P5 of the first fasteners 100, 100′ receive the first response signal Rs1, the second response signal Rs2 or the third response signal Rs3, the first fasteners 100, 100′ process the data according to each response signal, or enable the corresponding communication protocol such that the first fasteners 100, 100′ can start to communicate with the related second fasteners; or, another command signal to be issued to the related second fasteners 200, 200′ can be selected, and the corresponding pulse width signal Vp to be transmitted to the first contact points P1 can be generated according to the selected command signal. The corresponding pulse width signal Vp represents the selected command signal. At this time, each of the plurality of second fasteners 200, 200′ generates the corresponding response signal to be transmitted to the first fasteners 100, 100′ according to the received pulse width signal Vp, such that the first fasteners 100, 100′ obtain other related messages of each of the plurality of second fasteners 200, 200′. It is worth noting that the pulse width signal Vp transmitted to the first contact point P1 from the first fasteners 100, 100′ may not be related to the next pulse width signal Vp transmitted to the first contact point P1, and the present disclosure is not limited thereto. In this embodiment, the first fastener 100 and the second fasteners 200 that use four-wire transmission have the structures similar to that of the first fastener 100′ and the second fasteners 200′ that use five-wire transmission. Therefore, only the first fastener 100′ and the second fasteners 200′ that use five-wire transmission are described in the following.

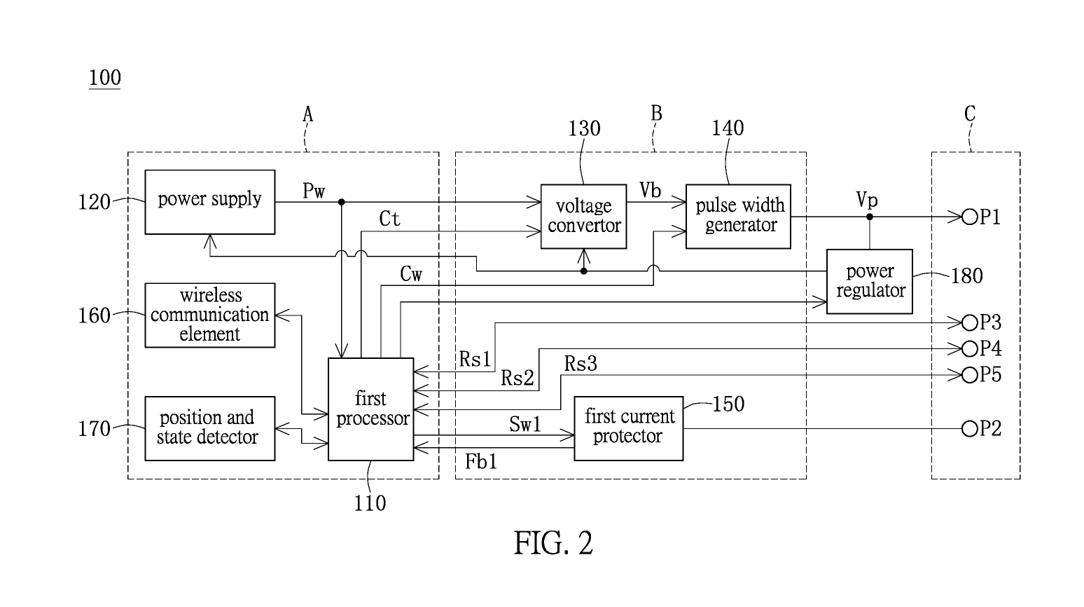

The internal structure and implementation of the first fastener 100 will be further described below. Further, referring to FIG. 2, a schematic diagram of the first fastener using the five-wire transmission according to an embodiment of the present disclosure is shown. As shown in FIG. 2, the first fastener 100 further includes a first processor 110, a voltage converter 130 and a pulse width generator 140. The first processor 110 receives a power Pw generated by a power supply 120 to be operated thereby. In this embodiment, the power supply 120 may be built in or externally attached to first fastener 100, the present disclosure is not limited thereto. In this embodiment, the power supply 120 may be a travel charger, a transformer, a power supply, or a power storage element, such as a mobile power supply or a battery, and the present disclosure is not limited thereto.

The first processor 110 stores a plurality of command signals and a plurality of communication protocols. In this embodiment, the first processor 110 includes one or more 8-bit, 16-bit, 32-bit or 64-bit MCU processors, or 8 bit˜64 bit MCU processors having Bluetooth, WIFI, SUB-G RF or other special functions, or SoC, SiP processors (MCU) having the aforementioned functions. The first processor 110 is programmed by an engineer to store the plurality of command signals or communication protocols and other processing programs. The first processor 110 may select one of the plurality of command signals and generate a voltage converting signal Ct and a control signal Cw according to the selected command signal to control the voltage convertor 130 and the pulse width generator 140 to respectively perform corresponding operations.

The voltage convertor 130 is coupled to the first processor 110 and receives the power Pw generated by the power supply 120. The voltage convertor 130 adjusts the voltage of the power Pw to a voltage level according to the voltage converting signal Ct to generate an adjusted voltage Vb. In this embodiment, the voltage convertor 130 is a buck converter, which adjusts the voltage of the power Pw to a voltage level, for example, from 12V down to 5V, according to the voltage converting signal Ct. In other embodiments, the voltage convertor 130 may also be a boost converter or other types of voltage converting element, the present disclosure is not limited thereto.

Referring to FIG. 2, the power regulator 180 is electrically connected to the first contact point P1, the voltage convertor 130 and the first processor 110. In this embodiment, the first fastener 100 may transmit the pulse width signal Vp through the first contact point P1 to inquire whether the second fastener 200 has a power to be supplied to the first fastener 100 when the second fastener 200 is electrically connected to the first fastener 100. If the second fastener 200 does not have an additional power source that may provide an electric energy to the first fastener 100, the power regulator 180 is not actuated. If the second fastener 200 has the additional power source such as mobile power or solar cells that can provide the electric energy to the first fastener 100, the first processor 110 may transmit a control signal to the power regulator 180 to control the power regulator 1800 to actuate and receive the electric energy from the second fastener 200 such that the power supply 120 stores the electric energy supplied by the second fastener 200. In this embodiment, the power regulator 180 may be implemented via different circuit designs, and thus the present disclosure is not limited thereto.

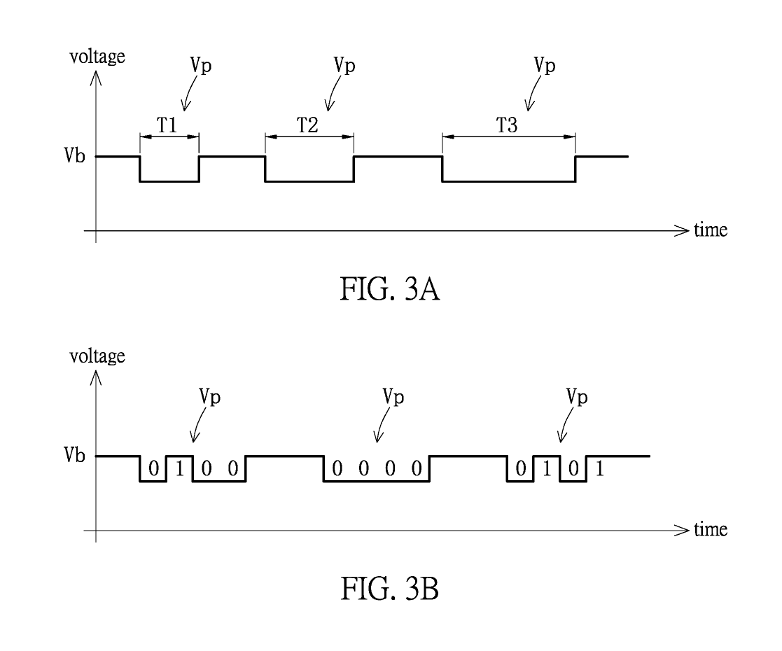

The pulse width generator 140 is coupled to the voltage converter 130 and the first processor 110. The pulse width generator 140 receives the adjusted voltage Vb and generates the pulse width signal Vp to be transmitted to the first contact point P1 based on the adjusted voltage Vb according to the control signal Cw. Further, the pulse width signal Vp is at a low voltage level for a predetermined time, is at a high voltage level for a predetermined time, or is a digital signal for a predetermined time. Further, referring to FIG. 3A, a schematic diagram of a pulse width signal according to an embodiment of the present disclosure is shown. As shown in FIG. 3A, the pulse width generator 140 generates three pulse width signals Vp having different predetermined times T1, 12 and T3 based on the adjusted voltage Vb, and the pulse width signals Vp are at a low voltage level. Each pulse width signal Vp is associated with the selected command signal. For example, the pulse width signal Vp having the predetermined time T1 represents calling to all of the second fasteners 200 combined with the first fastener 100; the pulse width signal Vp having the predetermined time T2 represents searching for all of the second fasteners 200 having specific functions; and the pulse width signal Vp having the predetermined time T3 represents notifying all of the second fasteners 200 combined with the first fastener 100 to communicate with the first fastener 100 in the single-wire transmission manner.

Further, referring to FIG. 3B, a schematic diagram of a pulse width signal according to another embodiment of the present disclosure is shown. As shown in FIG. 3B, the pulse width generator 140 generates three pulse width signals Vp that are different digital signals based on the adjusted voltage Vb. Each pulse width signal Vp is associated with the selected command signal. For example, the pulse width signal Vp is the digital signal “0100” and represents calling to all of the second fasteners 200 combined with the first fastener 100; the pulse width signal Vp is the digital signal “0000” and represents searching for all of the second fasteners 200 having specific functions; the pulse width signal Vp is the digital signal “0101” and represents notifying all of the second fasteners 200 combined with the first fastener 100 to communicate with the first fastener 100 in the single-wire transmission manner. Naturally, the pulse width signal Vp may also be represented by other types of signals, and the present disclosure is not limited thereto. As another example, the pulse width signal Vp may be simulated for a communication protocol, for example, a common clock synchronization signal such as SCK synchronization signal of SPI. It is worth mentioning that the total number of wires required for the standard SPI communication protocol is five or six wires, which includes three or four wires for communication of transmission protocols and two other wires for VCC and GND. However, after the SCK signal is replaced by the pulse width signal Vp, the total number of wires required for the SPI communication protocol can be reduced to four or five wires.

As another example, the pulse width signal Vp can simulate the common CS enable signal, or otherwise known as SCS, SS or chip enable (CE) signals, such as an SCS chip enable signal of SPI for the communication protocol. It is worth mentioning that the total numbers of wires required for the standard SPI communication protocol are five or six wires, which include three or four wires for communication of the transmission protocol and two other wires used for VCC and GND. However, after the SCS signal is replaced by the pulse width signal Vp, the total number of wires required for the SPI communication protocol can be reduced to four or five wires.

Optionally, the first fastener 100 further includes a wireless communication element 160 and a position and status detector 170. The first fastener 100 performs signal transmission with an external electronic device such as a mobile phone, a local server, a remote server, or another first fastener 100 via the wireless communication element 160. That is, in this embodiment, the first fastener 100 may also be used in different ways for signal transmission with another fastener 100, but the present disclosure is not limited thereto. In this embodiment, the wireless communication element 160 may include a Bluetooth communication device, a WiFi device, a Zigbee device, a mobile communication device, or RF modules having different carrier frequencies that fall within a frequency range of from 433 MHz to 5.8 GHz, one or more of which can be selected or cancelled.

The mobile communication element includes a third generation (3G) mobile communication technology communication element, a fourth generation (4G) mobile communication technology communication element, a fifth generation (5G) mobile communication technology communication element or a general packet wireless service communication element (GPRS).

The wireless communication element 160 may be incorporated in the first fastener 100 as described above, or one or more of the wireless communication elements 160 may be placed on the second fastener 200 so that the same effect can also be achieved.

The position and status detector 170 is configured to detect position or status information, such as latitude and longitude information, direction information, and acceleration information. In this embodiment, the position and state detector 170 may be a global positioning system detector (GPS), a triaxial accelerometer, an electronic compass, an indoor locator, an indoor positioning (Beacon) or a short-range wireless communication module, etc., from which one, more than one, or none may be selected. It is worth mentioning that the IC used for the short-range wireless communication can be shared with Beacon to add NFC functions such as security or identity recognition or electronic payment.

The position and status detector 170 may be incorporated in the first fastener 100 as described above, or one or more of the position and status detector 170 may be placed on the second fastener 200 so that the same effect can also be achieved.

As shown in FIG. 4A, in this embodiment, the pulse width generator 140 includes a p-type transistor MP, a Schottky diode or a general diode DS, a first N-type transistor MN1, and a second N-type transistor MN2. The p-type transistor MP has a first terminal, a second terminal and a p-type control terminal. The first terminal is connected to the voltage converter 130 to receive the adjusted voltage Vb. The second terminal is electrically connected to the first contact point P1, the p-type control terminal is electrically connected to the first terminal of the p-type transistor MP via a first resistance R1. The Schottky diode DS has an anode and a cathode. The anode is electrically connected to the first terminal of the p-type transistor MP and the cathode is electrically connected to the second terminal of the p-type transistor MP. The first n-type transistor MN1 has a third terminal, a fourth terminal and a first n-type control terminal. The third terminal is electrically connected to the p-type control terminal, the fourth terminal is grounded, and the first n-type control terminal is electrically connected to the first processor 110 to receive the control signal Cw. The second n-type transistor MN2 has a fifth terminal, a sixth terminal and a second n-type control terminal. The fifth terminal is electrically connected to the second terminal of the p-type transistor MP via a second resistance R2, the sixth terminal is grounded, and the second n-type control terminal is electrically connected to the p-type control terminal of the p-type transistor MP.

Therefore, the first processor 110 generates a control signal CW to be transmitted to the n-type transistor MN1 according to the selected command signal, and the voltage converter 130 generates an adjusted voltage to control the turning on and off of the p-type transistor MP, the first n-type transistor MN1 and the second n-type transistor MN2, such that the pulse width signal Vp representing the selected command signal to be transmitted to the first contact point P1 is generated. When the current consumed by the second fastener 200 is too small, the diode Ds may having insufficient buck; at this time, the diode Ds may reach a normal buck by the small current generated when the second n-type transistor MN2 and the resistor R2 are turned on such that the overall circuit can be operated normally. The transistor may be a general transistor or a field effect transistor. Naturally, the first processor 110 may also be another type of circuit, and is not limited by the present disclosure.

Referring to FIGS. 2 and 4B, in other embodiments, the first fastener 100 further includes a first current protector 150. The first current protector 150 is coupled to the first processor 110. The first current protector 150 detects a current flowing through the first current protector 150 and adjusts the first current protector 150 to a short-circuit state or an open circuit state according to the current. In this embodiment, the first current protector 150 includes a n-type transistor Mx and a current detecting resistance Rx, one terminal of the n-type transistor Mx is electrically connected to the second contact point P2, another terminal of the n-type transistor Mx is grounded via the resistance Rx. The control terminal of the n-type transistor Mx is electrically connected to the first processor 110 to receive a switch signal SW1, and a nodal point G between the n-type transistor Mx and the resistance Rx is electrically connected to the first processor 110 for transmitting a current detecting signal Fb1 to the first processor 110.

Therefore, the first processor 110 receives the current detecting signal Fb1 for detecting the current flowing through the first current protector 150, and turns off the transistor Mx when determining that the current detecting signal Fb1 is larger than a predetermined voltage representing the current flowing through the first current protector 150 to prevent the circuit elements in the second fastener 200 from being damaged. The corresponding voltage value of the predetermined voltage may be determined by the built-in program of the first fastener 100 when the second fastener 200 returns the device number to the first fastener 100.

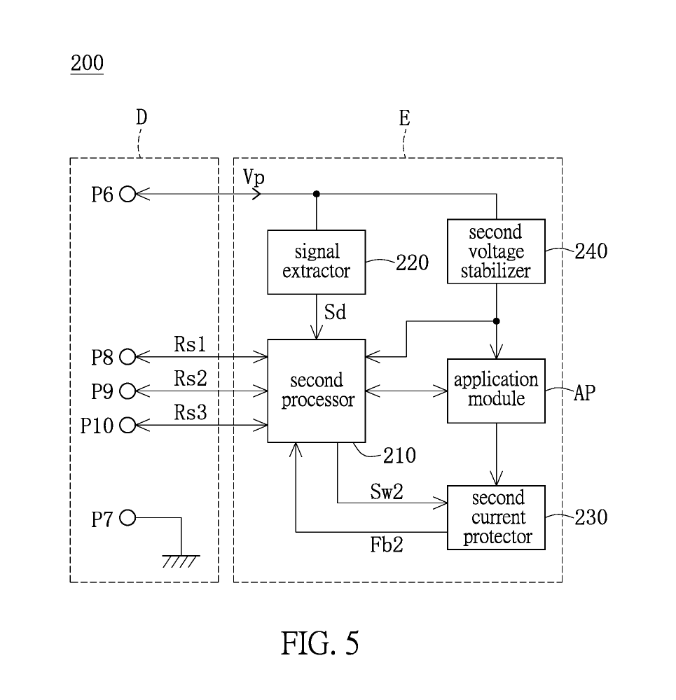

The internal structure and implementation of each of the plurality of second fasteners 200 will be further described below. Referring to FIG. 5, a schematic diagram of a second fastener according to an embodiment of the present disclosure is shown. As shown in FIG. 5, each of the plurality of second fasteners 200 has a signal extractor 220, a second processor 210 and a second voltage stabilizer 240. The signal extractor 220 is coupled to the sixth contact point P6 and receives the pulse width signal Vp to generate a extracting signal Sd to be transmitted to the second processor 210 based on the pulse width signal Vp. The second processor 210 is coupled to the signal extractor 220, the eighth contact point P8, the ninth contact point P9 and the tenth contact point P10, and generates the first response signal Rs1, the second response signal Rs2 or the third response signal Rs3 to be transmitted to the eighth contact point P8, a ninth contact point P9 or the tenth contact point P10 to control an application module AP according to the extracting signal Sd.

In this embodiment, the second fastener 200 using the five-wire transmission has three contact points that are the eighth contact point P8, the ninth contact point P9 and the tenth contact point P10 for signal transmission, and the first fastener 100 also has the third contact point P3, the fourth contact point P4 and the fifth contact point P5 correspondingly. In this embodiment, the first fastener 100 may receive or transmit the response signal by using at least one of the signal transmission contact points selectively, that is, the first fastener 100 may selectively use one contact point, two contact points, or three contact points for signal transmission. For the convenience of system design, the third contact point P3 may be set in advance as a signal transmission contact point of the single-wire communication protocol, or the third contact point P3 and the fourth contact point P4 may be set in advance as signal transmission contact points of a communication protocol requiring two transmission wires, or the third contact point P3, the fourth contact point P4 and the fifth contact point P5 may be set in advance as signal transmission contact points of a communication protocol requiring three transmission wires for signal transmission. In this embodiment, the second fastener 200 also has three transmission contact points, which are the eighth contact point P8, the ninth contact point P9 and the tenth contact point P10, with respect to the first fastener 100. Therefore, the second fastener 200 may also use one contact point, two contact points or three points for transmission according to actual requirements.

In other embodiments, the relationship between the transmission contact points and the communication protocols may be set in advance, for example, setting the third contact point P3 in advance as the signal transmission contact point of the single-wire communication protocol, setting the third contact point P3 and the fourth contact point P4 in advance as the signal transmission contact points of the communication protocol requiring two transmission wires, and setting third contact point P3, the fourth contact point P4 and the fifth contact point P5 in advance as the signal transmission contact points of the communication protocol requiring three transmission wires for signal transmission as described above. In this case, if the first fastener 100 uses a five-wire transmission, the first fastener 100 may be compatible with the second fasteners 200 using five-wire transmission, the second fasteners 200 using four-wire transmission and the second fasteners 200 using three-wire transmission. If the first fastener 100 uses four-wire transmission, the first fastener 100 is compatible with the second fasteners 200 using four-wire transmission and the second fasteners 200 using three-wire transmission.

The application module AP is an application function device disposed on the fastener 200. For example, the application module AP may be a touch panel, a screen, an image capturing element, various types of sensors, a heating sheet, or other application function devices, and is controlled by the second processor 210. The second voltage stabilizer 240 has one terminal connected to the fourth contact point P4, and another terminal through which a stable voltage is sent to the application module AP and the second processor such that the more sensitive sensor types or wireless (RF) types of the application module AP and the second processor 210 can have stable constant voltage sources.

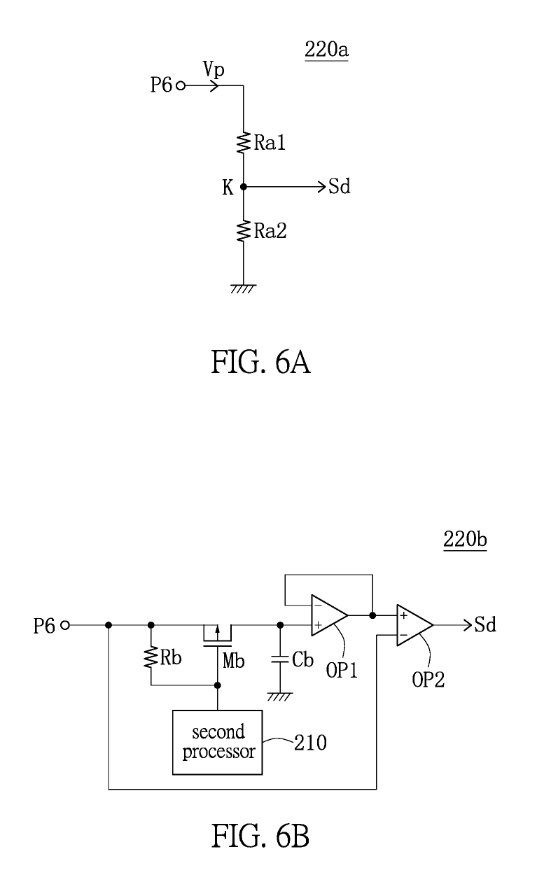

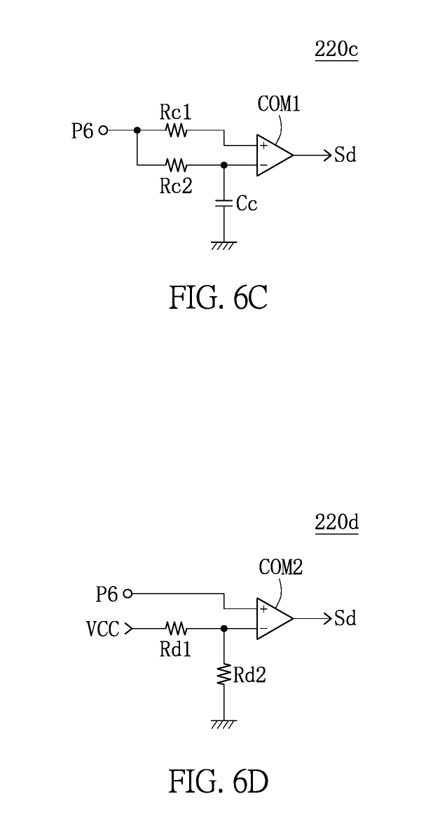

In other embodiments, as shown in FIG. 6A, the signal extractor 220a has two resistors Ra1 and Ra2. One terminal of the resistor Ra1 is connected to the fourth contact point P4, another terminal of the resistor Ra1 is electrically connected to one terminal of the resistor Ra2, and another terminal of the resistor Ra2 is grounded. A nodal point K between the resistor Ra1 and the resistor Ra2 is electrically connected to the second processor 210. Therefore, the signal extractor 220a receives the pulse width signal Vp and generates the extracting signal Sd to be transmitted to the second processor 210 at the nodal point K via the resistor Ra1 and the resistor Ra2, such that the second processor 210 obtains the extracting signal Sd representing the pulse width signal Vp.

Furthermore, FIGS. 6B to 6D illustrate other embodiments of the signal extractor. As shown in FIG. 6B, the signal extractor 220b has a resistor Rb, a transistor Mb, a capacitor Cb, a first amplifier OP1 and a second amplifier OP2. A first terminal of the transistor Mb is electrically connected to the sixth contact point P6, a second terminal of the transistor Mb is electrically connected to a positive input terminal of the first amplifier OP1. A control terminal of the transistor Mb is electrically connected to the first terminal of the transistor Mb via the resistor Rb. One terminal of the capacitor Cb is electrically connected to the second terminal of the transistor Mb and another terminal of the capacitor Cb is grounded. A negative input terminal of the first amplifier OP1 is electrically connected to an output terminal of the first amplifier OP1. A positive input terminal of the second amplifier OP2 is electrically connected to the output terminal of the first amplifier OP1. A negative input terminal of the second amplifier OP2 is electrically connected to the sixth contact point P6. An output terminal of the second amplifier OP2 is electrically connected to the second processor 210. Therefore, the signal extractor 220 receives the pulse width signal Vp, and the second processor 210 controls the control terminal of the transistor Mb to turn on or turn off the transistor Mb to generate the extracting signal Sd to be transmitted to the second processor 210.

As shown in FIG. 6C, the signal extractor 220c has a comparator COM1. A positive input terminal of the comparator COM1 is electrically connected to the sixth contact point P6 via the resistance Rc1. A negative input of the comparator COM1 is electrically connected to the sixth contact P6 via a resistor Rc2. One terminal of the capacitance Cc is electrically connected to the negative input terminal of the comparator COM1, and another terminal of the capacitance Cc is grounded. An output terminal of the comparator COM1 is electrically connected to the second processor 210. Therefore, the signal extractor 220c receives the pulse width signal Vp and compares a voltage at the positive input terminal with a voltage at the negative input terminal to generate the extracting signal Sd to be transmitted to the second processor 210, such that the second processor 210 obtains the extracting signal Sd representing the pulse width signal Vp.

As shown in FIG. 6D, the signal extractor 220d has a comparator COM2. A positive input terminal of the comparator COM2 is electrically connected to the sixth contact point P6. The positive input terminal of the comparator COM2 receives a voltage VCC generated by the second voltage stabilizer via the resistance Rd1. One terminal of a resistance Rd2 is electrically connected to the negative input terminal of the comparator COM2, and another terminal of the resistance Rd2 is grounded. An output terminal of the comparator COM2 is electrically connected to the second processor 210. Therefore, the signal extractor 220d receives the pulse width signal Vp and compares a voltage at the positive input terminal with a voltage at the negative input terminal to generate the extracting signal Sd to be transmitted to the second processor 210, such that the second processor 210 obtains the extracting signal Sd representing the pulse width signal Vp.

Further, referring to FIG. 5, the second fastener 200 further includes a second current protector 230. The second current protector 230 is coupled between the second processor 210 and the application module AP. The second processor 210 detects a current flowing through the second current protector 230 and adjusts the second current protector 230 to a short-circuit state or an open circuit state according to the current. The internal structure of the second current protector 230 is substantially the same as that of the first current protector 150, and thus it will not be redescribed herein. Therefore, the second processor 210 receives the current detecting signal Fb2 for detecting the current flowing through the second current protector 230, and adjusts the second current protector 230 to an open circuit state when determining that the current detecting signal Fb2 is greater than a predetermined voltage representing the current flowing through the second current protector 230 to prevent the circuit elements in the second fastener 200 from being damaged.

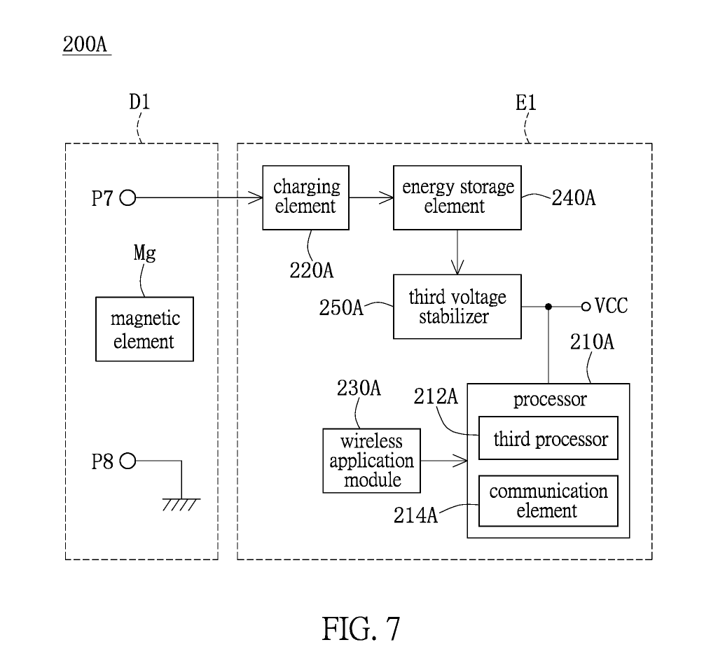

Referring to FIG. 7, a schematic diagram of a second fastener according to another embodiment of the present invention is shown.

The second fastener 200 includes a transmission interface D1 and a controller E1. The controller E1 is disposed at the seventh contact point P7 and the eighth contact point P8 by the magnetic force of the magnetic element Mg of the transmission interface D1. The application module AP of the controller E1 internally includes a small battery (e.g., an energy storage element 240A), and the second fastener 200 may be changed to become a short-distance or long-distance remote control when the second fastener 200 has any one of an RF module having different carrier frequencies such as Bluetooth, WIFI, or a 433 MHz to 5.8 GHz or other wireless communication modules. Alternatively, one or more third processors 212A such as 8 bit, 16 bit, 32 bit or 64 bit MCU processors, and a communication element 214A such as 8 bit to 64 bit processor (MCU) having a Bluetooth, WIFI, SUB-G RF, or other special functions, or SoC and SiP processors (MCU) having the aforementioned functions are built in the processor 210A, such that the second fastener 200A has wireless communication capability. The number of functional modules in the second fastener 200A may be increased according to actual requirements, and is not limited by the present disclosure.

For example, the second fastener 200A has a built-in rechargeable button battery as the energy storage element 240A. The application module AP of the second fastener 200A is a wireless application module 230A such as 1.2G wireless module combined with touch buttons, the wireless application module 230A performs two-way communication with the wireless communication module of the first fastener 100a in a wireless manner instead of three-wire transmission. If the second fastener 200A is removed from the transmission interface C and placed on a table, a backpack, or a bicycle handlebar, the application module AP becomes a remote-controlled touch button. At this time, if the second fastener 200A is connected to the transmission interface C of the first fastener 100, the second fastener 200A switches to being charged by the power supplied from the first fastener 100a, and its power may be stored in the energy storage element 240 through the charging element 220A. In this embodiment, the energy storage element 240 is electrically connected to the processor 210A and the voltage VCC. The energy storage element 240 may supply the voltage VCC via a third voltage stabilizer 250A.

For another example, the second fastener 200A has a built-in rechargeable button battery. The application module AP may be a second processor that is a voice input or voice recognition module integrated with a 1.2G or various wireless modules. At this time, if the second fastener 200A is connected to the transmission interface C of the first fastener 100, the second fastener 200A switches to being charged by the power supplied from the first fastener 100, and performs two-way communication with the wireless communication module of the first fastener 100a through a wireless manner instead of three-wire transmission. If the second fastener 200A is removed from the transmission interface C and placed on a table, a backpack, or a bicycle handlebar or built into the trademark position of a piece of clothing, it will become a wireless voice-controlled second fastener 200A.

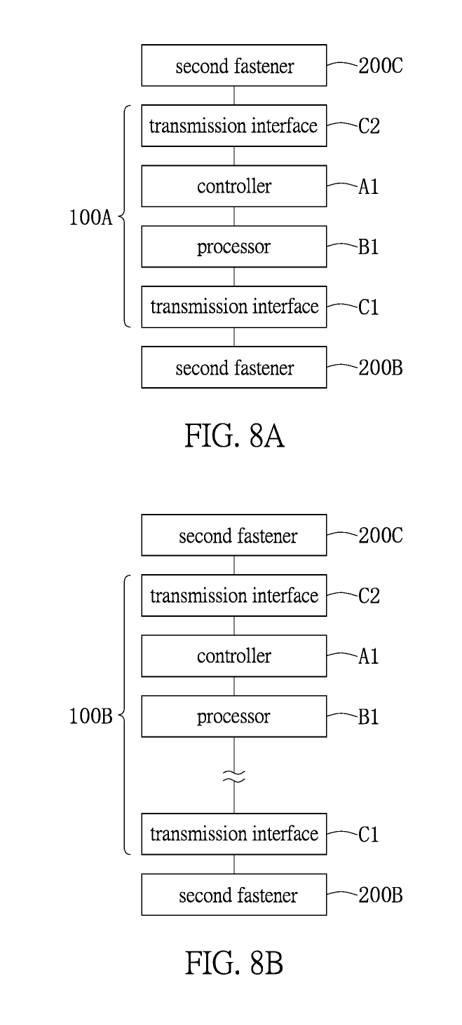

Referring to FIGS. 8A and 8B, schematic diagrams of a first fastener and second fasteners operating cooperatively according to an embodiment of the present disclosure are shown.

In this embodiment, the first fastener 100A, the second fastener 200B and the second fastener 200C may be configured as shown in FIG. 8A. That is, the second fastener 200B and the second fastener 200C are disposed at two sides of the first fastener 100A through the transmission interface C1 and the transmission interface C2, wherein the first fastener 100A is communicated with the second fastener 200B and the second fastener 200C via a controller A1 and a processor B1.

As shown in FIG. 8B, the second fastener 200C may be disposed at one side of the first fastener 100B through the transmission interface C2, the transmission interface C1 of the first fastener 100B may perform long-distance communication with the processor B1 and the controller A1 in a wired or wireless manner. Therefore, the transmission interface C1 may be disposed at a position having a predetermined distance from the processor B1 and the controller A1 of the first fastener 100B, so that the second fastener 200B may be disposed at the transmission interface C1 at a predetermined distance from the processor B1 and the controller A1 of the first fastener 100B. That is, the second fastener 200B may be disposed at a position farther from the first fastener 100B through the extension configuration of the transmission interface C1. This predetermined distance may be adjusted according to actual requirements, and is not limited by the present disclosure.

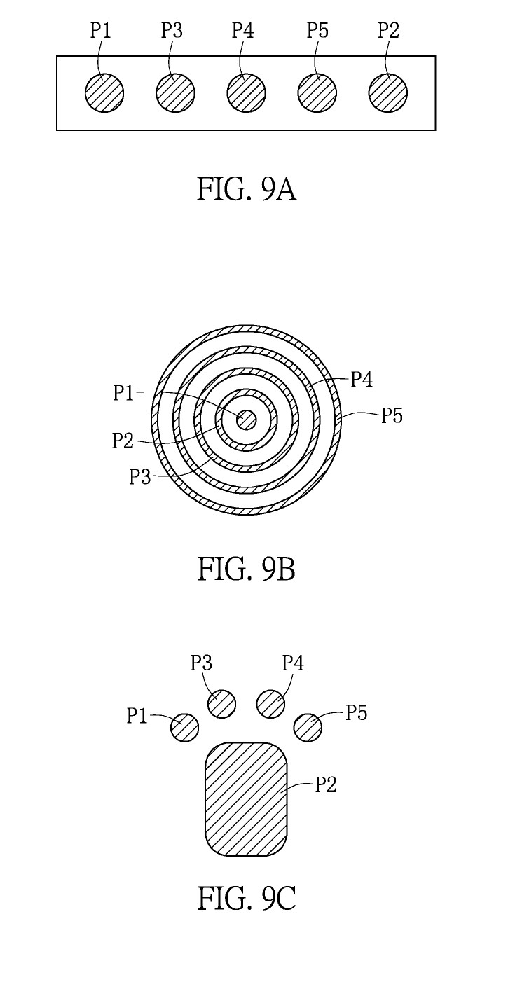

Reference is made to FIGS. 9A to 9C, configuration diagrams of a first contact point, a second contact point, a third contact point, a fourth contact point and a fifth contact point according to an embodiment of the present disclosure are shown.

As shown in FIG. 9A, the first contact point P1, the second contact point P2, the third contact point P3, the fourth contact point P4 and the fifth contact point P5 may be adjacently disposed in a straight line. As shown in FIG. 9B, the first contact point P1, the second contact point P2, the third contact point P3, the fourth contact point P4, and the fifth contact point P5 may be disposed along a concentric circle. As shown in FIG. 9C, the first contact point P1, the third contact point P3, the fourth contact point P4 and the fifth contact point P5 are designed as smaller contact points and disposed at one side of the second contact point P2. In other embodiments, the arrangement and the shape of the first contact point P1, the second contact point P2, the third contact point P3, the fourth contact point P4, and the fifth contact point P5 may be adjusted according to actual requirement, and the present disclosure is not limited to that disclosed herein. The configuration of the sixth contact point P6, the seventh contact point P7, the eighth contact point P8, the ninth contact point P9 and the tenth contact point P10 are designed corresponding to that of the first contact point P1, the second contact point P2, the third contact point P3, the fourth contact point P4 and the fifth contact point P5.

As described above, it can be seen that the first processor 110, the power supply element 120, the wireless communication element 160 and the position and state detector 170 are used as controllers A of the first fastener 100. The voltage convertor 130 and the pulse width generator 140 are used as processors B of the first fastener 100. The first contact point P1, the second contact point P2 and the third contact point P3 are used as transmission interfaces C of the first fastener 100. The fourth contact point P4, the fifth contact point P5 and the sixth contact point P6 are used as transmission interfaces D of the second fastener 200. The second processor 210, the signal extractor 220 and the application are used as controllers E of the second fastener 200. Therefore, the controller A controls the processor B to generate a corresponding pulse width signal Vp to be transmitted to the transmission interface C according to the command signal. The generated pulse width signal Vp is transmitted to the controller E through the transmission interface D from transmission interface C. The controller E generates a corresponding response signal Rs to be transmitted to the transmission interface D according to the pulse width signal Vp. The generated response signal Rs is transmitted to the controller A through the transmission interface C from the transmission interface D to integrate each of the plurality of second fasteners 200.

In other words, when the first fastener 100 is combined with the second fasteners 200, the first fastener 100 and the second fasteners 200 transmit power and different pulse width signals Vp corresponding to different command signals or different digital signals corresponding to different command signals to each other. The second fastener 200 analyzes the received signals and returns or reciprocates the response signals Rs to the first fastener 100. Therefore, the first fastener 100 may obtain the related message of each of the plurality of second fasteners 200 so as to integrate and control the application modules AP of each of the plurality of second fasteners 200.

The application module AP of the second fasteners 200 may be modules having various functionalities, such as touch keyboards, touch panels, bluetooth remote controllers, voice recognition controllers, smart watches, cameras, camcorders, GPSs, LEDs, battery modules, mobile power sources, sensors, vibrators, mobile phones, electronic payment modules, indoor positioning modules (Beacons), heating films, USB charging cords extending through two wires, humidity sensors, pressure sensors, barometric pressure sensors, alcohol concentration detectors, CO2 sensors, air quality PM2.5 monitors, heartbeat sensors, UV sensors, PIR human body detectors, inertial sensors, motion sensors, acceleration sensors, gesture recognizers, fingerprint readers, eye trackers, gyroscopes, magnetic field sensors, electronic nose modules, alcohol sensors, infrared temperature sensors, brain wave controlling and detecting modules, toxic gas detectors, laser indicators, laser receivers, laser or ultrasonic rangefinders, electronic compasses, electronic compass modules, wireless interphones, bluetooth interphones, WIFI camcoders, WIFI communicators, NFC modules, infrared transmitters, chip cards, membership cards, financial cards, electronic passports, 2D or 3D barcode scanners, women's anti-wolf alarms, mosquito repellents, dog repellents, clothes heater chips, timer modules, radio modules, memory card readers, wireless pen drives, infrared remote controllers, ultraviolet sterilizers, LED direction indicator lights, LED brake lights, night anti-collision LED warning lights, LED flashlights, ultra-small video recorders, interference or anti-wireless pinhole cameras, microphones, SOS distress signal transmitters, energy collectors, ultra-small wind power generators, small vibration power generators, small hand-cranked power generators, power banks, rechargeable batteries, OLED displays, electronic paper displays, LED displays, but the present disclosure is not limited thereto.

The common second fastener 200, such as the second fastener 200 having a voice input or the touch input function, may be directly built into the clothing according to practical requirements, such that the transmission interface C of the first fastener 100 and the transmission interface D of the second fastener 200 may be omitted and a more aesthetical effect may also be achieved.

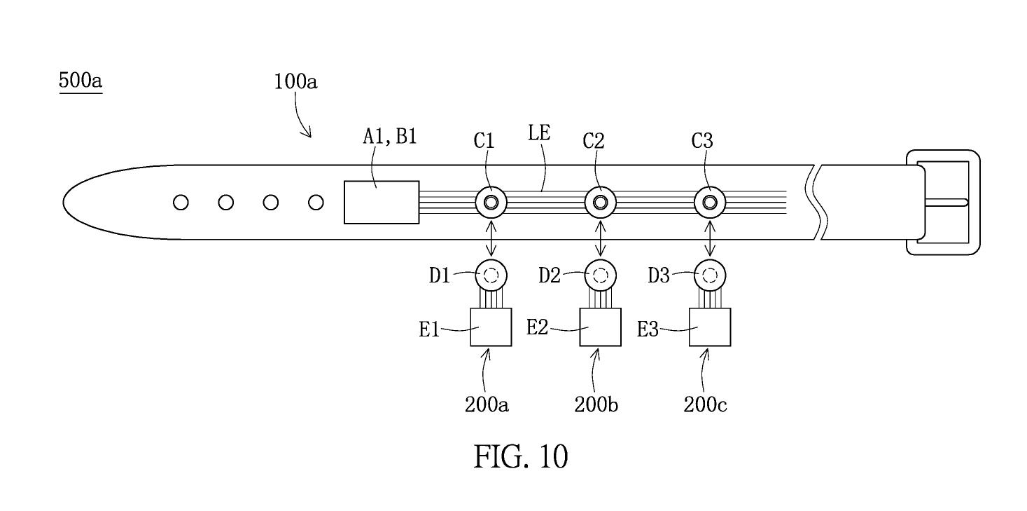

The wearable device 500a using the five-wire transmission will be exemplified as a belt in the following description. Reference is made to FIG. 10, a schematic diagram of a belt as a wearable device using five-wire transmission according to an embodiment of the present disclosure is shown. As shown in FIG. 10, the wearable device 500 using five-wire transmission has a first fastener 100a and three second fasteners 200a, 200b and 200c. The first fastener 100a is disposed on the belt and has a controller A1, a processor B1, a plurality of transmission interfaces C1, C2 and C3. The controller A1 and the processor B1 are disposed at the same position on the belt. The five-wire line LE is electrically connected to the processor B1 and is distributed across the belt. The transmission interfaces C1, C2, and C3 are electrically connected to the three wires.

The second fastener 200a has a transmission interface D1 and a controller E1; the second fastener 200b has a transmission interface D2 and a controller E2; and the second fastener 200c has a transmission interface D3 and a controller E3. The transmission interface D1, the transmission interface D2, the transmission interface D3 are combined with the transmission interface D4, the transmission interface D5 and the transmission interface D6 respectively such that the first fastener 100a is connected to the second fasteners 200a to 200c in parallel.

Therefore, the first fastener 100 may be communicated with the second fasteners 200a to 200c via the five-wire line LE (that is, five-wire transmission), thereby integrating the functional elements of all of the second fasteners 200a to 200c combined with the first fastener 100. The controller A1, the processor B1, the plurality of transmission interfaces C1, C2 and C3 of the first fastener 100 and the transmission interfaces D1 to D3 and the controller E1 to E3 of the second fasteners 200a to 200c are substantially the same as the controller A, the controller B, the plurality of transmission interfaces C of the first fastener 100 and the transmission interface D and the controller E of the second fasteners 200 in the above embodiment, and thus it is not redescribed herein.

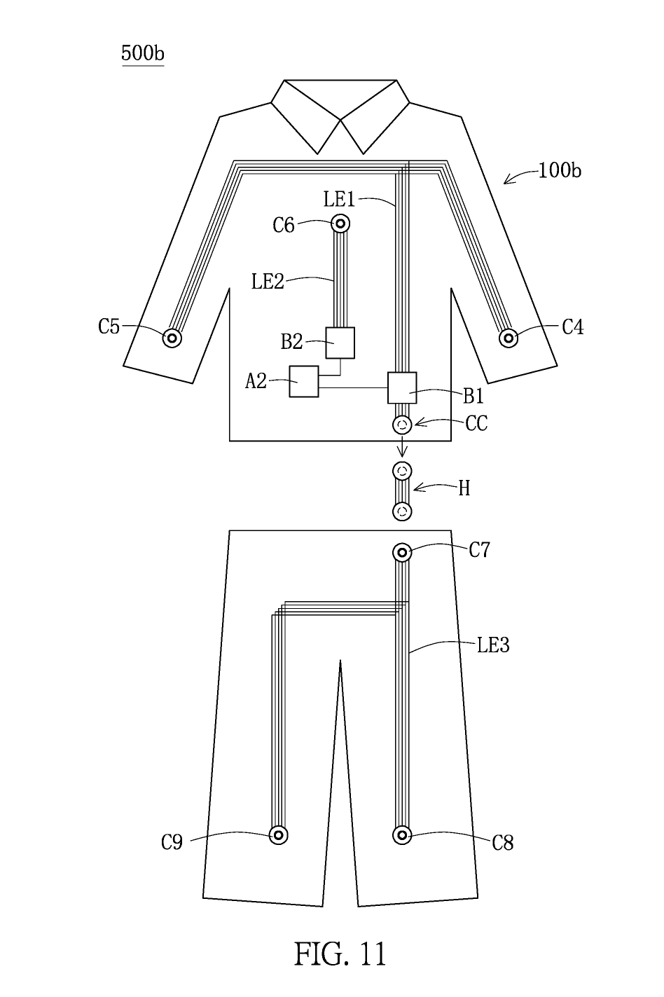

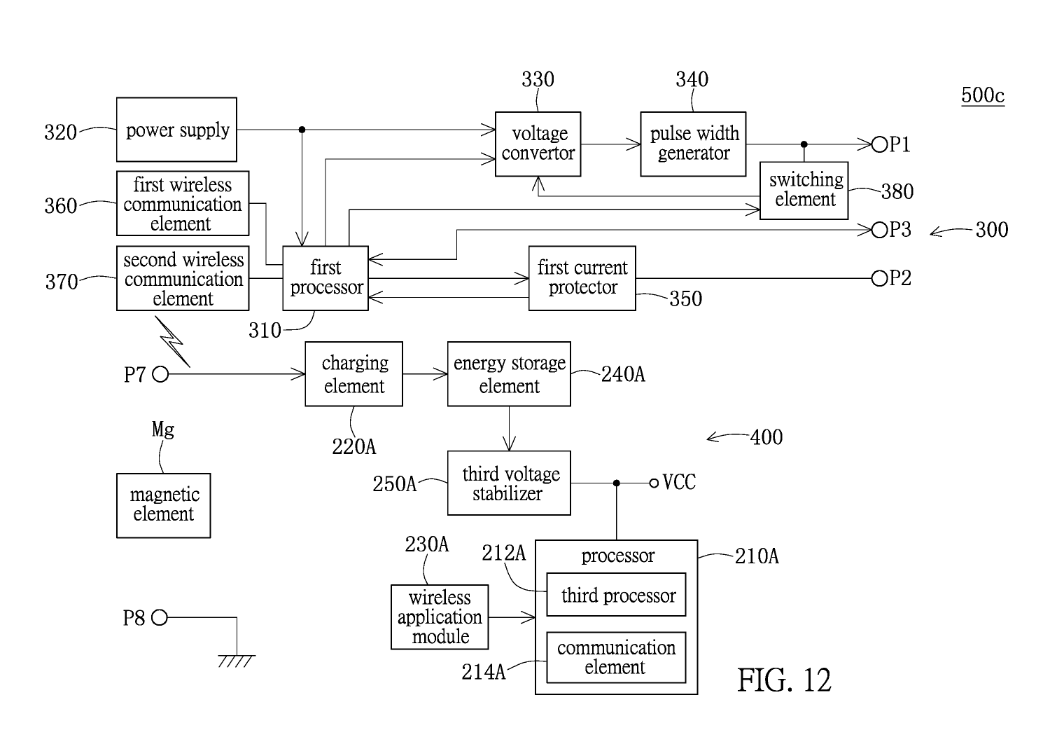

Further, referring to FIG. 11, a schematic diagram of a piece of clothing and pants as wearable devices using multi-wire transmission according to an embodiment of the present disclosure is shown. The internal structure of the second fastener is substantially the same as that in the above embodiment, and thus it is not shown in FIG. 11 again. The first fastener 100b of the wearable device 500b using five-wire transmission is disposed on the clothing, and has a controller A2, two processors B1, B2 and a plurality of transmission interfaces C5, C6, C7, C8, C9. The controller A2 is electrically connected to the processors B1, B2 respectively and disposed at the same position on the piece of clothing as the processors B1, B2.

The five-wire line LE1 is electrically connected to the processor B1 and distributed on the piece of clothing. The five-wire line LE2 is electrically connected to the processor B2 and distributed on the piece of clothing. The five-wire line LE3 is distributed on the pants. The transmission interfaces C4, C5 are electrically connected to the five-wire line LE1, the transmission interface C6 is electrically connected to the five-wire line LE2, and the transmission interfaces C7, C8, C9 are electrically connected to the five-wire line LE3. The extension wire H connects the transmission interface CC electrically connected to the processor B1 with the transmission interface C7 such that the processor B1 may transmit the pulse width signals Vp to the transmission interfaces C7 to C9 synchronously.

It is worth noting that in the configuration of the five-wire lines LE1 to LE3 and the processors B1 to B2, the second fastener disposed on the five-wire lines LE1 and the LE3 may be a low-power electronic component, such as a touch screen, a screen, an image capture components, or various sensors, etc. The second fastener disposed on the five-wire line LE2 may be a high-power electronic component, such as a heating film, a small fan, or mobile phone charger. Under these circumstances, the five-wire wire lines LE1 and LE3 may be made of thinner wires, and the five-wire lines LE2 should be made of thick wires. Naturally, the second fastener disposed on the five-wire lines LE1 to LE3 may also be configured according to particular implementations, and the present disclosure is not limited thereto.

The foregoing descriptions are merely embodiments of the present disclosure and not intended to limit the scope of the present disclosure.

What is claimed is:

1. A wearable device using multi-wire transmission, comprising:
a first fastener having a first contact point, a second contact point, a third contact point and a fourth contact point, the first fastener including a first processor configured to store a plurality of command signals and a plurality of communication protocols; wherein the first fastener selects one of the plurality of command signals and generates a pulse width signal to be transmitted to the first contact point according to the selected command signal, and wherein the pulse width signal represents the selected command signal; and
a plurality of second fasteners each having a sixth contact point, a seventh contact point, an eighth contact point and a ninth contact point, the plurality of second fasteners being detachably bonded to the first fastener;
wherein the first contact point, the second contact point, the third contact point and the fourth contact point are electrically connected to the sixth contact point, the seventh contact point, the eighth contact point and the ninth contact point of each of the plurality of second fasteners respectively when the first fastener is bonded to the plurality of second fasteners;
wherein the sixth contact point of each of the plurality of second fasteners receives the pulse width signal from the first contact point and generates at least one response signal to be transmitted through both or one of the eighth contact point and the ninth contact point to the first fastener according to the pulse width signal, the third contact point and the fourth contact point of the first fastener receive each of the corresponding response signals to obtain a related message of each of the plurality of second fasteners when the first fastener is bonded to the plurality of second fasteners;
wherein one of the plurality of second fasteners performs signal transmission with the first fastener according to any one of the plurality of communication protocols.

2. The wearable device using multi-wire transmission of claim 1, wherein the first fastener further includes a fifth contact point, the second fastener further includes a tenth contact point, and wherein, when the first fastener and the plurality of second fasteners have been combined or newly combined to each other, the sixth contact point of each of the plurality of second fasteners receives the pulse width signal from the first contact point, the second fastener generates at least one response signal to be transmitted through the eighth contact point, the ninth contact point, the tenth contact point or a combination thereof to the first fastener according to the pulse width signal; the third contact point, the fourth contact point or the fifth contact point of the first fastener receives each of the corresponding response signals to obtain the related message of each of the plurality of second fasteners.

3. The wearable device using multi-wire transmission of claim 1, wherein the first fastener is connected in parallel or in series with the plurality of second fasteners.

4. The wearable device using multi-wire transmission of claim 1, wherein the first fastener selects one of the plurality of communication protocols to inquire the plurality of second fasteners, at least one of the plurality of second fasteners having the selected one of the communication protocols performs bidirectional communication with the first fastener according to the communication protocol, and the second fasteners that do not have the selected one of the communication protocols among the plurality of second fasteners temporarily not involved in communication.

5. The wearable device using multi-wire transmission of claim 4, wherein when the first fastener selects another one of the communication protocol to inquire the plurality of second fasteners, at least one of the plurality of second fasteners having another communication protocol performs bidirectional communication with the first fastener according to another communication protocol.

6. The wearable device using multi-wire transmission of claim 1, wherein a newly added second fastener transmits a signal to the first fastener through the eighth contact point, the ninth contact point, the tenth contact point or a combination thereof when the newly added second fastener is electrically connected to the first fastener.

7. The wearable device using multi-wire transmission of claim 1, wherein the second fastener stores one or more communication protocols among the plurality of communication protocols.

8. The wearable device using multi-wire transmission of claim 1, wherein the first fastener generates the pulse width signal according to one of the plurality of communication protocols and transmits the pulse width signal to the plurality of second fasteners, at least one of the plurality of second fasteners having the communication protocol returns a response signal to the first fastener during a predetermined time period according to the pulse width signal and the communication protocol.

9. The wearable device using multi-wire transmission of claim 1, wherein the pulse width signal is at a low voltage level for a predetermined time, is at a high voltage level for a predetermined time, or is a digital signal for a predetermined time, the predetermined time being associated with the selected command signal.

10. The wearable device using multi-wire transmission of claim 1, wherein the pulse width signal as a synchronization signal is transmitted through a transmission wire, without an additional synchronization signal transmitted through an additional transmission wire such that the total numbers of transmission wires required for the communication protocol are reduced.

11. The wearable device using multi-wire transmission of claim 1, wherein the pulse width signal is an enable signal, without an additional transmission wire used for enabling during data transmission of the transmission protocol.

12. The wearable device using multi-wire transmission of claim 1, wherein the first fastener further includes:
a first processor storing the plurality of command signals, the first processor being configured to select one of the plurality of command signals and generate a voltage converting signal and a control signal according to the selected command signal, and being configured to process the plurality of communication protocols;
a voltage converter coupled to the first processor, the voltage converter being configured to receive a power and adjust a voltage of the power to a voltage level according to the voltage converting signal to generate an adjusted voltage; and
a pulse width generator coupled to the first processor and the voltage converter, the pulse width generator being configured to receive the adjusted voltage and generate the pulse width signal to be transmitted to the first contact point based on the adjusted voltage according to the control signal.

13. The wearable device using multi-wire transmission of claim 12, wherein the first fastener further includes:
a communication element through which the first fastener is connected to an external electronic device, another one of the first fastener or another one of the second fastener.

14. The wearable device using multi-wire transmission of claim 13, wherein the communication element includes a Bluetooth communication component, a WiFi communication component, a Zigbee communication component or a mobile communication component, and a radio frequency module having different carrier frequencies that fall within a frequency range of from 433 MHz to 5.8 GHz, a third generation (3G) mobile communication technology communication element, a fourth generation (4G) mobile communication technology communication element, a fifth generation (5G) mobile communication technology communication element or a general packet wireless service communication element (GPRS), one or more of which may be selected.

15. The wearable device using multi-wire transmission of claim 12, wherein the first fastener further includes:
a position detector configured to detect position information of the first fastener, wherein the position detector is a global positioning system detecting element, a triaxial accelerometer, an electronic compass, an indoor positioning module, or a short-range wireless communication module.

16. The wearable device using multi-wire transmission of claim 12, wherein the first fastener further includes:
a first current protector coupled to the first processor, the first processor being configured to detect a current flowing through the first current protector and adjust the first current protector to a short-circuit state or an open circuit state according to the current.

17. The wearable device using multi-wire transmission of claim 12, wherein the pulse width generator includes:
a p-type transistor having a first terminal, a second terminal and a p-type control terminal, the first terminal is electrically connected to the voltage converter to receive the adjusted voltage, the second terminal is electrically connected to the first contact point, and the p-type control terminal is electrically connected to the first terminal through a first resistance;
a Schottky diode having an anode and a cathode, the anode being electrically connected to the first terminal, the cathode being electrically connected to the second terminal;
a first n-type transistor having a third terminal, a fourth terminal and a first n-type control terminal, the third terminal being electrically connected to the p-type control terminal, the fourth terminal is grounded, and the first n-type control terminal is electrically connected to the first processor to receive the controlling signal; and
a second n-type transistor having a fifth terminal, a sixth terminal and a second n-type control terminal, the fifth terminal being electrically connected to the second terminal through a second resistance, the sixth terminal is grounded, and the second n-type control terminal is electrically connected to the p-type control terminal.

18. The wearable device using multi-wire transmission of claim 1, wherein each of the plurality of second fasteners further includes:
a signal extractor coupled to the fourth contact point for receiving the pulse width signal and generating a extracting signal based on the pulse width signal; and
a second processor coupled to the signal extractor and the sixth contact point, the second processor being configured to generate the response signal or a data to be transmitted to the sixth contact point according to the extracting signal and control an application module.

19. The wearable device using multi-wire transmission of claim 18, wherein each of the plurality of second fasteners further includes:
a second current protector coupled between the second processor and the application module, the second processor being configured to detect a current flowing through the second current protector and adjust the second current protector to a short-circuit state or an open circuit state according to the current.
